(19) United States
(12) Patent Application Publication
(10) Pub. No.: US 2006/0255141 A1
(43) Pub. Date: Nov. 16, 2006

(54) Machine readable data

(76) Inventors: Dusan Kocis, Bratislava (SK); Ivan Kocis, Bratislava (SK)

Correspondence Address: ABELMAN, FRAYNE & SCHWAB, 666 THIRD AVENUE, 10TH FLOOR, NEW YORK, NY, 10017, US

(21) Appl. No.: 10/568,138

(22) PCT Filed: Aug. 6, 2004
(86) PCT No.: PCT/SK04/00009

§ 371 Date: Feb. 8, 2006

(30) Foreign Application Priority Data
Aug. 8, 2003 (SK) PP 1007-2003

(51) Int. Cl. G06K 7/10; G06K 19/06

(52) U.S. Cl. 235/454; 235/494

(57) ABSTRACT

The invention is concerned with data channel of the background containing symbolic data marks, which include aggregate, constant number of dark elements in the whole record where the core is the recording medium such as paper or other carrier of the symbolic data marks printed on this media arranged into a grid on positions with periodically repeating properties in both horizontal and vertical directions, textual or graphical print, printed in overlay with data symbolic marks, elements of modulation of the record by graphic pattern. The invention relates to the system of creation and method of preparation of the data channel of the background.

### TECHNICAL FIELD

The invention relates to a data channel of the background, sytem of its creation and method of its preparation and usage. This method provides the recording and reading of data channel of the background created by two-dimensional marks representing binary data placed on paper or on other carrier, alongside or overlaid by human readable data, or patterns.

This invention also involves a representation with such characteristics that the efficiency of dark pattern elements in a symbolic data mark for the representation of dual status is higher in comparison with the current practice.

The invention involves transparent protection of documents by means of data channel of the background created by two-dimensional marks which, if overlaid by the original print form of a document, can carry the full data and safety information from the electronic form to the printed form and back to the electronic form without losses, with the full reconstruction of the document.

It is possible to modulate the symbolic data marks by a pattern or line pattern without disturbing the resolution ability of the data symbolic marks.

Data representation is such that the number of dark elements is constant regardless of data represented by marks. The number of necessary dark elements for the same level of dual statuses recognition is smaller in comparison with the current practice.

### BACKGROUND ART

Methods of recording machine readable marks on paper or another carrier are very miscellaneous, depending on the purpose of marks usage.

There are known many methods of placing the marks readable by a human as well as by a machine (for instance machine readable cheques with appropriate shaped numerals).

In this group of recording there were attempts to combine human and machine readable data representations, for instance in U.S. Pat. No. 5,606,628: Apparatus and method for generating bit-mapped patterns of print characters.

There are developed two-dimensional representations in the group of methods using bar code with sophistic methods of self-correcting and self-synchronising characteristics, solved e.g. in U.S. Pat. No. 4,939,354 “Dynamically variable machine readable binary code and method for reading and producing thereof, U.S. Pat. No. 5,337,362 “Method and apparatus for placing data onto plain paper”, U.S. Pat. No. 3,643,068 “Arrangement for the automatic identification of information on a non perforated data processing card”, U.S. Pat. No. 4,998,010 “Polygonal information encoding article process and system”, U.S. Pat. No. 4,692,603 “Optical reader for printed bit-encoded data and method of reading same”, U.S. Pat. No. 4,924,078 “Identification symbol, system and method”, U.S. Pat. No. 5,327,510 “Method of recording/reproducing data of grid pattern, and apparatus thereof”, U.S. Pat. No. 5,278,400 “Multiple threshold encoding of machine readable code.”

These techniques require their own separated area on a paper to record data marks on the paper, and are disturbing for human. The data capacity of a code is limited by the area allocated for the code.

Demand for machine readable record in conjunction with human readable data limits technology usage and resulted in “hidden” or “embedded” techniques.

Some technologies of copyright protection enable data to be inserted in an original text or pattern (watermarking, steganography). These methods are limited as concerns the volume of data inserted, and require large extent of calculations.

Here it is possible to mention U.S. Pat. No. 5,636,292 “Steganography methods employing embedded calibration data” and “Electronic marking and identification techniques for deterrent of copying document” by J. Brasil and collective, IEEI Infocom 94, 1278-1287.

Some technologies insert copyright or other information into the background of document by means of marks placed on selected background places, for instance U.S. Pat. No. 5,568,550: Method and system for identifying documents generated by an unauthorised software copy, U.S. Pat. No. 5,436,974 Method of encoding confidentiality markings, U.S. Pat. No. 5,917,996 “System for printing tamper-resistant electronic form characters”.

Techniques similar to those using wedge code are solved for instance by U.S. Pat. No. 3,959,631 “Wedge code and reading thereof”.

These techniques led to more sophisticated techniques, to the group named as glyph representation of digital data. These techniques are more developed as concerns data embedding in a larger paper area (or other substrate), for instance see U.S. Pat. No. 4,754,127 “Method and apparatus for transforming digitally encoded data into printed data strips”, U.S. Pat. No. 5,245,165 “Self-clocking glyph code for encoding dual bit digital values robustly”, U.S. Pat. No. 5,091,966 “Adaptive scaling for decoding spatially periodic self-clocking glyph shape codes, U.S. Pat. No. 5,168,147 “Binary image processing for decoding self-clocking glyph shape codes”, U.S. Pat. No. 5,315,098 “Methods and means for embedding machine readable digital data in halftone images”, U.S. Pat. No. 5,486,686 “Hardcopy lossless data storage and communications for electronic document processing systems”.

However, even these techniques are not transparent in regard to the usable document area, and they are not transparent in regard to application. Human and machine readable document forms are placed on their own dedicated places and do not overlap each other. Freedom of using printable document area is considerably restricted.

There is one requirement, that machine readable data representation is to be minimally disturbing for a human-reader, scattered data marks are to be of a minimal possible contrast with even grey level perceived by a reader.

The submitted invention is based on such representation of digital data dual status that elements dedicated for the representation of the complementary binary values dual status are placed in distant places in regard to the axes of symmetry of the place of a two-dimensional mark.

The requirement of an even integral density level of dark elements excludes some forms of representation which change the contents of the dark elements in a mark according to a represented logical value. Likewise, such representations are excluded, which use forms not suitable for accurate localisation of marks position (for instance round forms).

Each element participating in whole representation of dual binary values is placed on such position that its distance to one or two axes of symmetry of a symbolic data mark (1, 2, 3, 14) is the maximal possible one.

Analyses showed that the form and location of the dark elements of a symbolic data mark significantly influenced its characteristics for determination of its exact location during the reading of symbolic data marks and thereby the quality and stability of the process of mark reading in an ambient with severe noise and geometrical distortions of printing and scan process.

With respect to the above mentioned, it is helpful to define some bearing lines on the body of a mark in both directions to enable as easy and stable algorithm of correcting expected mark position as possible. Such lines for one preferred execution are for instance lines parallel to lines of equal distance to both axes of symmetry of a mark.

From this point of view it is helpful to place dark points onto an interval given by their maximal distance from an equidistant line to both axes of symmetry.

The location of dark elements is therefore given by three basic limitations: the maximal aggregate of distances from both the axes, maximal allowed distance from both the axes of symmetry and boundaries of the area allocated for a symbolic data mark (2b, 3 and 11).

Analyses also showed that the dark elements of a symbolic data mark, which are placed close to an axis of symmetry of this mark, are almost invariant and they do not increase the discriminability of the binary values represented by the symbolic data mark but contribute only to the total integral value of the dark elements of the representation.

This part of the area dedicated for mark representation can be used for placing dark elements according to the value of modulation performed by a pattern or graphic information (12).

Other method of modulation represents increasing the number of dark elements by their addition to another mark elements in free locations most distant from the axes of symmetry of the mark area (13).

The aggregate of dark elements shall be minimal, but not lower than the threshold value which affects the discriminability of the binary status represented by them.

An optimal position of the location of these elements on the most outlying free location of the mark area in regard to the axes of symmetry of the mark area is given for each chosen maximal number of dark elements appropriated to one symbolic data mark.

### DISCLOSURE OF INVENTION

Disclosure of patent is data channel of the background containing symbolic data marks, which include aggregate, constant number of dark elements in the whole record, which is characterized by:

Recording medium, such as paper or other recording print carrier.

Data symbolic marks printed on record medium arranged into a grid on positions with periodically repeating properties in both horizontal and vertical directions.

Textual or graphical print printed in overlay with data symbolic marks.

Elements of modulation of the record by graphic pattern.

Disclosure of patent is also the system for data recording on paper, or other carrier, and reading machine readable marks, which is characterized by:

Means for transforming and formatting source data to a sequence of digital data embedded in individual symbolic data marks.

Means for coding such data sequence onto a format consisting of a description of a symbolic data mark in the language of the used printing method.

Means dedicated for printing a record on paper or other printing substrate.

Means for reading data symbolic marks from paper or other carrier into a computer.

Means for transforming the read data of the data sequence format which are represented by individual symbolic data marks.

Means for transforming into the format of data which served as a source for recording symbolic data marks or to other chosen format.

Means for modulation of marks by a source graphic pattern.

Disclosure of patent is also the method of recording, determination of the location and number of dark elements for coding dual represented statuses in a symbolic data mark for data recording and reading on paper or other carrier of such mark, wherein these dark elements represent on an area available for one symbolic mark two statuses with constant number of dark elements, which change only position, is characterized by:

Determination of the axes of symmetry of a two-dimensional area dedicated for a symmetric data mark and determination of a coordinate system in regard to these symmetry axes.

Determination of the aggregate area of the mark, i.e. the number of dark elements used for coding two statuses for data representation on area allocated for the symbolic data mark.

Determination of the maximal allowed distance of dark points from a line of equal distance from both the axes of symmetry and minimal allowed distance from each of the symmetry axes.

Calculation of the aggregate of the absolute values of both co-ordinates for each possible location of a dark element.

Determination of areas of maximal distance from both the axes in compliance with the aggregate and allowed maximal and minimal distances from axes.

Recording one half of the maximal allowed number of elements in one of the areas determined in previous step within the limits of the area allocated for the symbolic data mark as one half of a symbol representing one of the two statuses which could be represented by the symbolic data mark.

Recording the second half of the maximal allowed number of elements in the next of the determined areas on the opposite side of both the symmetry axes, within the limits of the area allocated for the symbolic data mark as the second half of the symbol representing one of the two statuses which could be represented by the symbolic data mark.

Choosing the locations of dark elements located symmetrically to the second symmetry axis with respect to the recorded elements as locations of elements representing the second status of two statuses representing the symmetric data mark.

Determination of the areas of maximal distance from each of the symmetry axes individually.

Recording the maximal allowed number of elements in one of the determined areas within the limits of the area allocated for the symbolic data mark as a symbol representing one of the two statuses which could be represented by the symbolic data mark.

Choosing the locations of dark elements located symmetrically to such an axis of symmetry that does not intersect the chosen locations of dark elements with respect to the recorded elements as the locations of the elements representing the second status of the two statuses represented by the symbolic data mark.

The subject of this invention is also based on a method of recording symbolic data marks by means of dark and light elements placed on a paper or similar carrier of printed information, which includes:

Defining a grid of two systems of axes, a horizontal one and a vertical one, perpendicular to each other with equal or different relative distance in horizontal and vertical directions, on a paper area dedicated for recording symbolic data marks.

Determining a maximal allowed number of dark elements for a symbolic data mark.

Placing one system of symbolic data marks onto the area of lines connecting two intersections of each horizontal axis with vertical axes in a way, that a one logical status represented by the symbolic data mark has the majority or all of its dark elements placed on one half of the mentioned connecting line or close to it and the second logical status represented by the symbolic data mark has the majority or all its dark elements placed on the second half of the mentioned connection line or close to it.

Placing the second system of symbolic data marks in the area of lines connecting two intersections of each vertical axis with horizontal axes so that a one logical status represented by the symbolic data mark has the majority or all of its dark elements placed on one a half of the mentioned connecting line or close to it and the second logical status represented by the symbolic data mark has the majority or all its dark elements placed on the second half of the mentioned connection line or close to it.

Placing dark elements to positions maximal outlying to the centre of a line connecting intersections of the two systems of axes.

Placing the dark elements of the mark in such a way, that they are in minimal allowed distance from the mentioned intersections of the horizontal and vertical axes.

Placing the dark elements of the mark in such a way, that they are in maximal distant from a line connecting intersections of the horizontal and vertical axes.

The subject of the invention involves also a method of a transparent protection of a document dedicated for printing, which is transparent in regard to application as well as to the data contents of the document by means of a field of symbolic data marks printed overlaid by the print of the proper document, ensuring selective data and security continuity of electronic and paper document in both directions i.e. from electronic version of a document to a form printable on paper and from the paper form of the document back to the electronic version of the document, which consists of:

Extracting a part of the data contents dedicated for document protection, that can include also positional information on the printed document, from a file dedicated for print by an original application.

Extracting other document contents, including also invariable data for a set of documents of the same kind, from the file dedicated for print by the original application.

Transforming the data extracted in the first, eventually also in the second step, according to algorithms including also cryptographic, compress algorithms and procedures, electronic signature, self corrective coding and data preparation for mark modulation by a graphic information.

Transforming the data to a form suitable for printing a field of two-dimensional symbolic data marks representing the mentioned data as described e.g. in other items of this invention, but not limited to them, arranged in rows and columns, placed on a print document on its substantial area, independently of the area used for the print of the original document, the full file data of which were used as the input.

Printing performed by overlaying of the print of the original document which is printed concurrently or in time sequence with the print of two-dimensional data symbol marks on one substrate, or on paper.

Scanning this printed protected document by a scanner or other similar equipment and input of the scanned data into a computer.

Processing of the read data of the mutually overlaid print of the original document by the field of symbolic data marks, recognising, extracting the data represented by the field of symbolic data marks.

Transforming the recognised and extracted data by a set of algorithms including also cryptographic, decompress algorithms and procedures, electronic signature, self corrective decoding.

Visualisation of these recognised and processed data, i.e. the part of the data contents determined for protection.

Linking the recognised and processed data with the data of other document contents resulting in a full reconstruction of the file document in its complete form, however not limited on the complete form only.

Visualisation of the complete document on a visualising equipment.

The invention relates also to data channel of background, which contains data symbolic marks containing an aggregate constant number of dark elements in the whole record, and which consists of: record media like paper or other carrier of data symbolic marks printed on record medium, arranged onto a grid on positions with periodically repeating characteristics in horizontal as well as vertical direction; text or graphic print printed in an overlay with data symbolic marks; elements of record modulation performed by a graphic pattern.

The submitted invention will be described in the next text in connection with preferred executions of the invention, however it is evident that the invention is not narrowed and limited on these executions only. On the contrary, the intention is to cover all such alternatives, modifications and equivalents which could be included in the sense and scope of the invention defined in the attached part of claims. Recording data on paper or other carrier as a method suitable for machine reading is optimised basically from three points of view. Firstly, from the point of view of density of recorded data on a unit area; secondly, from the point of view of the reliability, velocity of the reading process, its resistance against disturbing influences which include geometrical distortions during print process, distortions during reading process (scanning) and a presence of a disturbing noise such as distortions of printing details, or presence of other print overlaying recorded data marks, or subsequent damage of recorded data parts.

The third point of view represents such characteristics of marks selected for data representation, which makes these marks less disturbing for a reader, does not require allocated reserved area of the printed document which is dedicated for data only and is tolerant to an overlay by a normal text print in regard to its normal readability and machine readability of marks.

An increased record density imposes increasing demands on accurate localisation of data representing marks, quality of print and demands on recognition of represented logical data marks. This results in importance of feature of marks enabling permanent position feedback during reading individual marks, when their dimensions are already comparable, or smaller than the tolerances and distortions of print and scan process. An increasing record density leads to increased calculation demands during the process of recognising their recorded logical status.

The forms of marks and the locations of their components must allow recognition of the marks in few steps but robust algorithms enabling both fast and simple correction of their expected position and tolerance to failures of larger extent.

In most cases, the area allocated for the representation of an elementary mark carrying dual binary data is of a rectangular shape in a two-dimensional area. It results from the fact that we embed a maximum data available in a total area available in the form of a rectangle grid of symbolic data marks.

The most famous methods are based on the area characteristic of marks and not on brightness characteristics.

In the case when the goal shall be a co-existence of a printed text with data marks on the same area in an overlay, there is a requirement for homogenous appearance of a data marks field on the substrate of the printed text, so that a reader is not disturbed by their summary level during recognition of the text or other printed patterns and the level includes for instance from 5% to 15% of maximal dark elements in the total available printing area

The submitted invention uses in its one aspect the fact that in maintaining the total number of dark elements, a record of dark elements shall be performed on the most outlying alternative positions in regard to the axes of symmetry of an area dedicated for a mark.

One implementation of the invention uses symrnetry to both axes of symmetry concurrently for the recording of marks. The second implementation uses for mark recording each symmetry axis individually.

### BRIEF DESCRIPTION OF DRAWINGS

FIG. 1 and FIG. 2 show an area of a favourable location of dark elements.

On FIG. 3 there are given Vₑₚ values for a possible location of dark elements on the area of a symbolic data mark of the size of 10×10 elements.

FIG. 4, FIG. 5 and FIG. 6 show possible configurations of dark elements.

FIG. 7 and FIG. 8 show the location of dark elements according to the common technical practice.

FIG. 9, FIG. 10 and FIG. 11 show various examples of a dark elements arrangement according to the invention.

FIG. 12 shows an example of a dark element configuration for modulation of data symbolic marks by dark elements.

FIG. 13 shows a next realisation of modulation by dark elements.

FIG. 14 shows a next favourable implementation according to the invention.

FIG. 15 shows areas evaluated at reading a data symbolic mark sequentially in both directions by both axes of symmetry.

FIG. 16 shows mark area modulation by dark elements placed in the surrounding of the intersection of the symmetry axes, in an area not influencing the discrimination quality of the mark.

FIG. 17 shows a procedure using a separate protected path for a part of information with a separate invariable standard contents (mask, blank form).

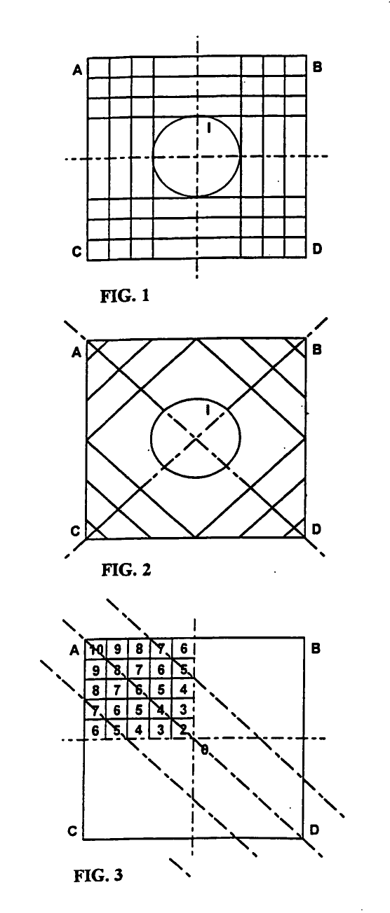

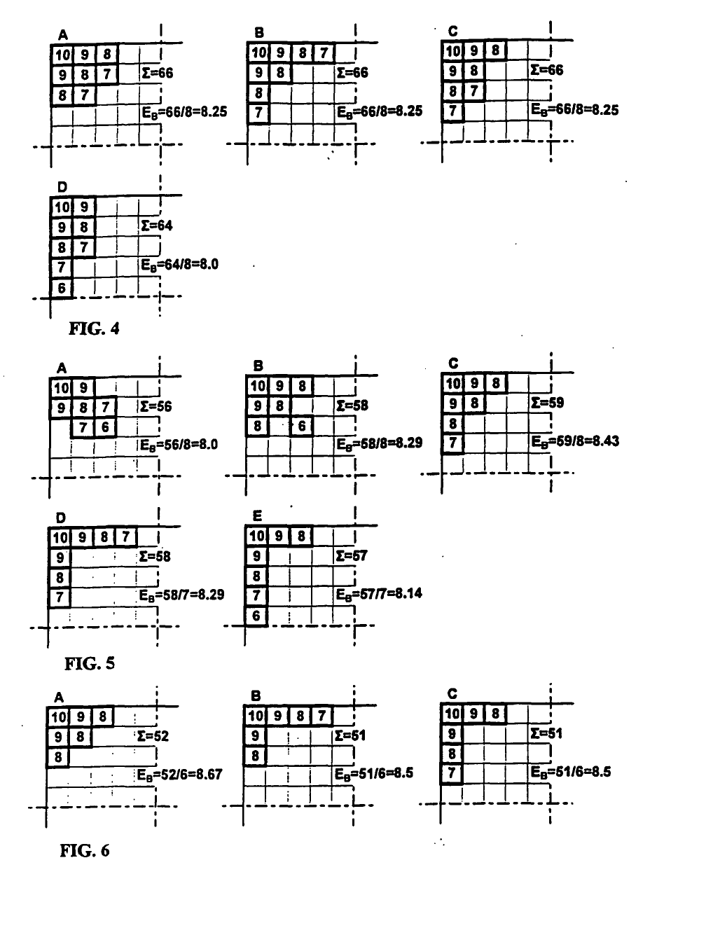

### BEST MODE OF CARRYING OUT THE INVENTION

The first implementation according to this invention is shown on 1 and 2. Areas most outlying from both axes of symmetry along their sides are situated in the ABCD areas in four corners of the area of the mark.

The weighing function of elements location Vₑₚ=|Cₓ|+|C_{y}| gives for each location of a dark element a value which is the aggregate of the distances from both symmetry axes (Cₓ and C_{y} represent element co-ordinates in regard to the individual axes).

3 shows Vₑₚ values for possible location of dark elements on the area of a symbolic data mark of the size 10×10 elements.

Apparently, the elements of outlying corners are multiply significant for discriminability of the binary statuses. An example of a mark realisation according to this invention is such that one status is given by a presence of dark elements in the most outlying corners of the area of the mark (A, D), and the second status is given by presence of dark elements in other two corners (B, C) and by absence of dark elements in the complementary corners of the area.

Other implementation according to this invention could be such that one status of a symbolic data mark is given by presence of dark elements in outlying positions of the area A and outlying positions of the area B, and the second status is given by presence of dark elements in areas of other two corners C and D and by absence of dark elements in the complementary areas (A and B). It is apparent that similarly one status can be represented by presence of elements in the areas A and C and by an absence in the second two areas (B and D), and the second status by presence of dark elements in the areas B and D and by absence in the areas A and C.

It is apparent that centrally located areas are less suitable for coding various statuses and contribute to discriminability of these statuses minimally.

4, 5, 6 show possible configurations of dark elements (one corner and a half of elements are shown only), where the number of dark elements is a parameter (16 elements, 14 elements, 12 elements).

It is possible to assign the sum Vₑp of participating elements for each shown configuration of dark elements and the efficiency of participating elements in regard to the discriminability ED
E_{D}=ΣᵢVₑₚ/number of participating elements

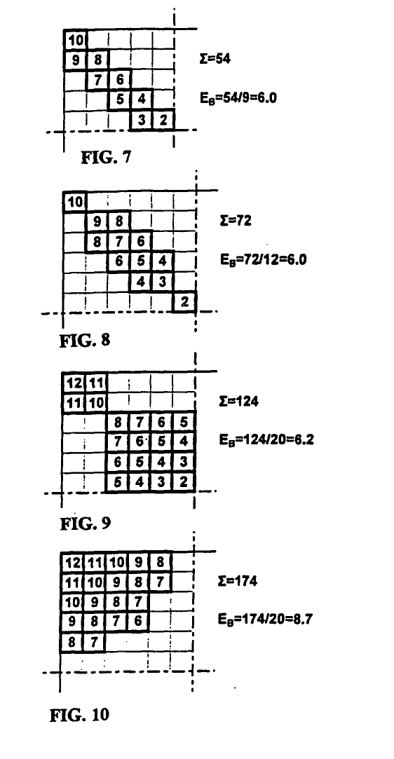

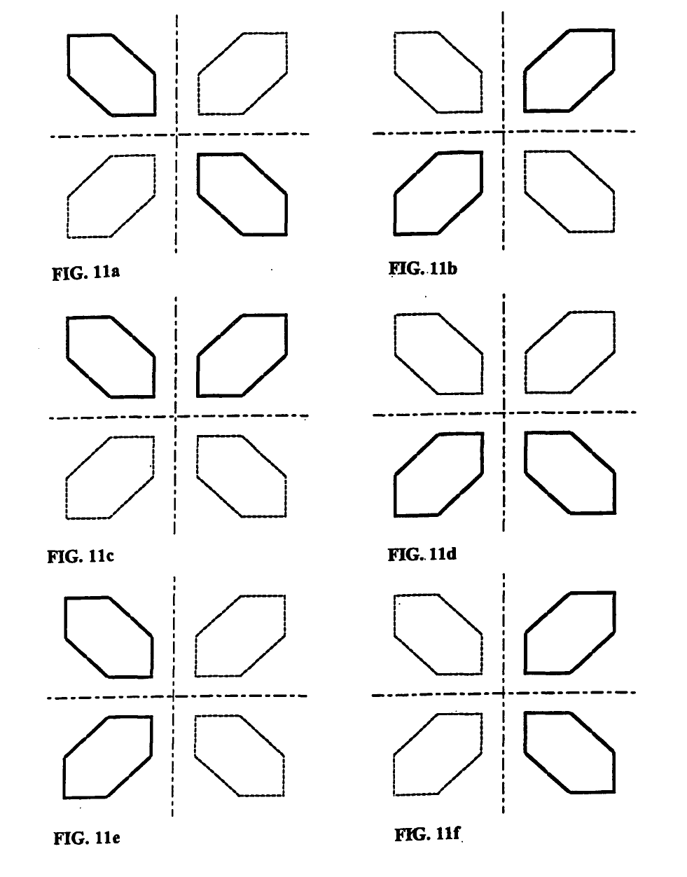

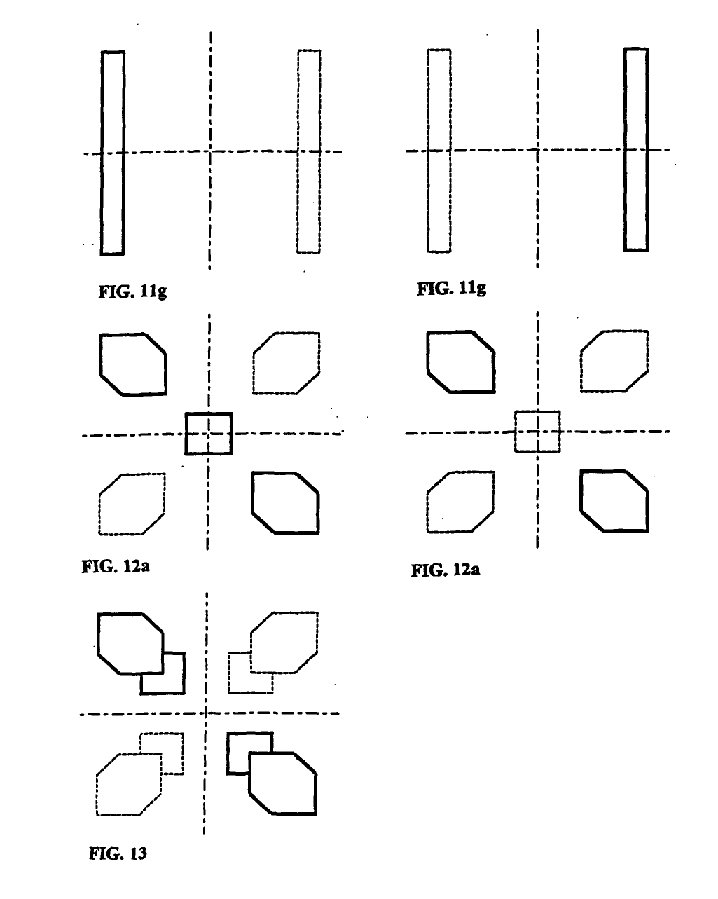

As shown on these pictures, for each number of maximal allowed dark elements an optimal arrangement of dark elements is given. FIG. 7 and FIG. 8 show the method used in the previous common technical practice and illustrate the small contribution of the central areas of a mark, but significant contribution as regards filling the number of maximal allowed dark elements.

9, 10, 11 show various examples of realisation of arrangement of dark elements according to the invention.

An example of the method of discrimination between two statuses of a symbolic data mark is shown on 11, that is based on adding quantitative values of an element scheme of two corners symmetrical to both axes and subtracting of the aggregate of the quantitative value of an element scheme of the two remaining areas symmetrical in regard to those previous by both axes.

The sign of the result refers to the represented binary mark status. In some cases it is more optimal to use a more complicated, but still computing simple procedure which gives a reliable result of the represented value and at the same time also correction of the expected location of the area of a mark.

12 show an example of configuration of dark elements for modulation of an area of data symbolic marks by dark elements which in a total grid of data symbolic marks represent a graphic pattern (for instance logo, text, etc.). Modulating dark elements are recorded in this case into the central area of the mark and can be of various number according to the modulation degree. These dark elements neither improve nor retrograde the discriminability of the represented status of the symmetric data mark. The number of grey scheme levels, which can be recorded as modulation, is given by the maximal allowed element number for modulation.

13 shows such a next realisation of modulation by dark elements, that dark elements of modulation are added to the dark elements representing a logical value. Modulating elements contribute to discriminability of two represented statuses of a mark.

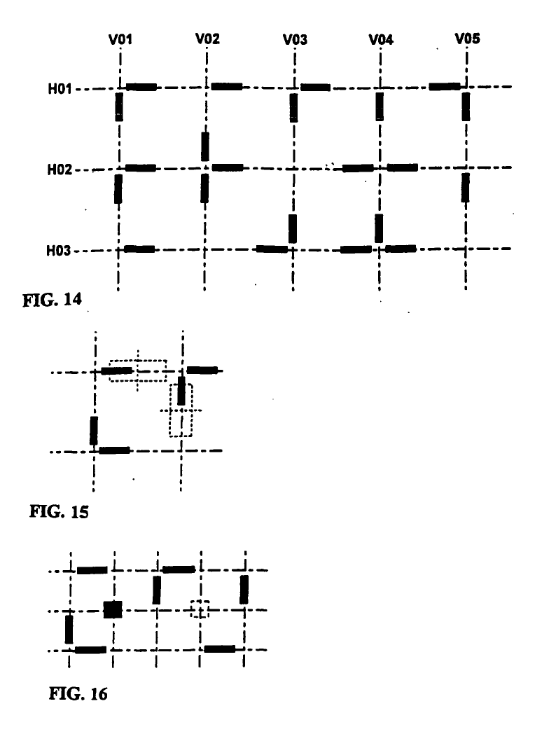

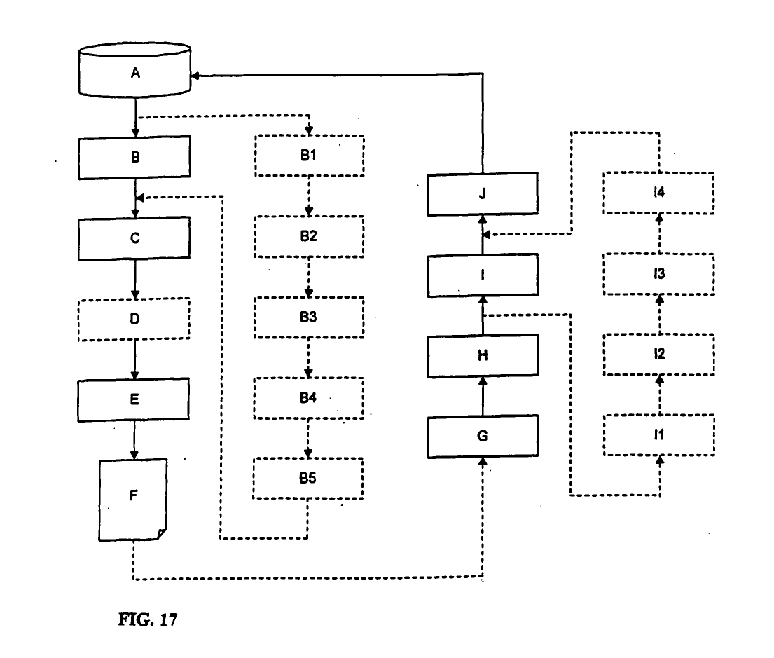

A next preferred implementation according to the invention is on FIG. 14, where two systems of data symbolic marks are shown, each using symmetry by one symmetry axis. Such an arrangement is favourable for determination of mark location correction and reading algorithm efficiency. The number of dark elements necessary for representation of one bit is smaller then that one of the previous common technical practice.

15 shows areas which are evaluated at reading data symbolic mark concurrently in both directions by both symetry axes.

16 shows modulation of the area of a mark by dark elements located in the surroundings of the intersection of the symmetry axes in the area which does not influence the discrimination quality of the mark.

Properties of symbolic data marks, the robustness of algorithm of reading and initialisation thereof create necessary preconditions for feasibility of using a field of marks printed on one substrate as an overlay with the inherent document, relatively independently on its density. Printing an inherent document as an overlay over a field of marks carrying information represents just disturbances in an information channel in a large scale. The submitted solution uses a selective extraction of protected information from a file or from other data source (generally all alphanumerical marks, with their positional information) which are processed and then represented by a field of symbolic data marks. Repeated patterns and graphical shapes (for instance logo) are not changed in the given category, type of a document and can be transmitted by a single-shot, independent path. On the place of document reconstruction, after reading the field of marks and their processing (for instance electronic signature, decryption etc.), this part will be combined with the invariable part (mask, blank form) in a whole corresponding to the original document visually, however with confirmed contents.

17 shows a process using a separate protected path for a part of information with a separate invariable standard contents (mask, blank form). Both parts will be merged on the place of reconstruction and verification.

### EXAMPLE 1

One favourable implementation according to one aspect of the invention is described. A two-dimensional area dedicated for recording of symbolic data marks will be divided into a grid of horizontally and vertically repeating areas available for location of one mark. For a unit area available, a symmetry axis will be determined in horizontal as well as vertical direction. Lines of equal distances from both the symmetry will be determined. The maximal aggregate area of an unit symbolic data mark, i.e. the maximal number of dark elements for representation of one logical status by a mark will be determined. For each possible position of a dark element, the aggregate of its distances to both the axes of symmetry will be determined.

The maximal allowed distances of dark elements from the lines of equal distances from the symmetry axes will be determined. The areas of the maximal aggregate of the dark element distances from both the symmetry axes will be determined.

One half of the maximal number of dark elements will be recorded in one of four such areas so that the aggregate of their distances from both the axes is the maximal one, and at the same time these elements are not more outlying to the line of equal distances from the symmetry axes than a maximal distance allowed by us and so that these elements are recorded in available area of a mark.

The second half of the maximal number of dark elements will be recorded in an area symmetrically located in regard to both symmetry axes of available area of the mark.

For representation of the second logical status, areas symmetrical in regard to one symmetry axis of available area of the mark will be used.

For purposes of modulation by a graphical or line pattern we place a certain number of dark elements corresponding to a modulation of one available mark area close to the intersection of the axes of symmetry of the available area of the mark.

During reading such recorded marks, the status of four areas of the maximal distance from the expected symmetry axes will be evaluated in regard to presence of dark elements in number exceeding threshold.

Comparing the number of elements of two diagonally outlying areas with the number of those laying in areas symmetrical by one symmetry axis, the first approximation of determination of the value represented by the mark will be obtained, next approximation will be obtained by checking the presence of dark elements in couples of not diagonally located areas in a number exceeding threshold value.

The value represented by the mark as well as the correction for position of the next symbolic data mark will be obtained following the results of these comparisons and checks.

Localisation of positions of the beginnings and ends of the rows and columns of the areas of symbolic data marks for this favourable implementation will be carried out by evaluation of positions of image points from margin of paper in relation to the periodicity of compressing, encryption, self-correction coding, electronic signature, time marking. The data specified for modulation of the protected document (such as logo, graphical patterns, state symbol, etc.) will be transformed further to the form and format of the collection of symbolic data marks.

Further, these data will be transformed to a format for printing of symbolic data marks according to other aspects of this invention. Consequently, the whole collection of symbolic data marks and the human readable form of original document prepared for printing on a printing substrate, mostly on paper, will be printed in overlay. A protected document will be created thereby. It is possible to send non-changing standard parts of the document (blank form, logo etc.) to a place where the document will be reconstructed, authorised and used.

On the place of usage and authentication (checking), the document will be scanned to insert it in a computer, further, reading data symbolic marks according to other aspects of this invention will be carried out, and transformation of the detected and extracted data according to the collection of algorithms, including the compressing, encryption, self-correction coding, electronic signature, time marking etc., will be carried out in order to reconstruct and authenticate the data recorded in a machine readable form. Further, the data will be merged with the data transmitted by other communication line and the result thereof will be viewed or used for next processing in a computer on the place of checking or data using. Such a favourable implementation of one aspect of the invention represents a data channel on the background of human readable data, where such channel assures data and security continuation by means of printed document. Such implementation represents, contrary to OCR techniques, 100% data reconstruction on paper and uses mechanisms of the current common technical practice developed for protection of electronic documents.

### EXAMPLE 4

The system 17 consists of a facility (block) B, which transforms input data representing critical information A, which are subject to protection, by known (usual) way to a series (chain) of binary data. This transformation can include e.g. encoding of data B1, electronic signing of data B2, their encoding by self-correction code (e.g. Reed-Solomon B3), permutating such data B4 and, finally, formatting according to type of protected document B5. These resulting data correspond at binary level to binary (logical) values which will be inserted into symbolic data marks in the following block of the system facility, block of de-coding symbolic data mark C.

In the block of de-coding symbolic data mark the binary data are in concrete format regards presence of dark areas, and the value represented by the symbolic data mark and one component of the correction of the mark location will be exactly determined by comparing quantitative values of the darks elements. Comparing the aggregates of values of the dark elements of both the sides of the expected connection line of intersections will provide one component correction of the mark location. These steps of mark reading will be carried out for both systems of marks. With this implementation, modulation of the marks area will be carried out by placing an appropriate number of dark elements (according to the modulation intensity in the given point—in the given mark) close to the intersection of the symmetry axes of the connection lines of the intersections of both axes systems.

With this favourable implementation, localisation of the beginnings and ends of the rows (columns) of the areas of symbolic data marks will be performed so that presence of dark points will be searched sequentially from a margin of the paper in individual scanned rows (pixels). In the next step, a linear approximation will be carried out on all the first detected dark points in each scanned row, and all points from the original collection, which are in bigger distance from the straight line of this linear approximation than specifically determined distance, will be excluded. Consequently, a new linear approximation will be put on the remaining points, and once more the points, which are in bigger distance than the distance smaller than that one used in the previous step, will be excluded. This step will be repeated till the difference of the most outlying point to the straight line of the running linear approximation is not smaller than the given minimum. The specification of nearest points will be carried out similarly also in the remaining three directions. The first symmetric mark will be found on a straight line parallel to the straight line of the last linear approximation in the half distance of the vertical axes distance. Moreover, the location of the mark in the second direction will be obtained likewise.

### EXAMPLE 3

Following the next favourable implementation, a transparent protection of a document prepared printing will be performed. This document uses data symbolic marks according to other aspects of this invention, where the whole data form of the document or some parts thereof will be recorded on one printing substrate overlaid with a human readable document form. It is possible to read and reconstruct backward the original data form of the document. Favourable implementation of the invention according to this aspect consists of extracting the data contents, or a part thereof, specified for protection from the file dedicated for printing by the original application. These data will be transformed by a collection of algorithms including variation of presence of dark points, where the first point having such characteristic determines one initial co-ordinate of the origin of the rows (columns).

Eliminating distortions of the beginnings of individual rows (columns) will be reached by creation of a curve that is a linear approximation of all found beginnings of rows (columns) and by placing a straight line parallel to such linear approximation and by a translation moving of such straight line till to its first contact with the linear approximation and subsequent rotation thereof around this point till a second intersection is found. Further, the outlying points of the original collection of the found beginnings are filtered and periodical concentration of points (clusters) is detected. This process will be repeated in other three directions from a margin of the paper and the perpendicularity and parallelism of resulting four straight lines will be detected, and the position of non-parallel (non-perpendicular) straight line will be corrected following the findings as well as the position of the margins of marks will be determined according to at least three straight lines.

### EXAMPLE 2

The second favourable implementation of recording symbolic data marks consists of utilisation of placing dark elements symmetrically to a one axis of symmetry only. Two systems of axes, a horizontal one and a vertical one, perpendicular to each other, will be specified in the whole area specified for symmetric data marks. One system of marks will be placed on connection lines between the intersections of the first system of axes with the second system of axes and the second system of marks will be placed on the connection lines between the intersections of the second system of axes with the first system. The maximal number of dark elements appropriate for a representation of one status of a symbolic data mark will be specified. Dark elements will be recorded onto locations maximally outlying to the middle of a connection line of intersections, thus to the axis of the symmetry of the mark. Dark elements of marks will be placed (recorded on the substrate) so that all or most of dark points of one logical status will be located on one half of the mentioned connection line or close to it, while the minimal given distance from the intersections of axes and maximal given distance from the connection line of the intersections are defined for dark elements. According to the second represented status, all or majority of dark elements located on the opposite half of the mentioned connection line, with keeping the limitations of distances from connection lines and intersections.

For this peripheral implementation, reading recorded marks consists of evaluation of the status of areas on both sides from the middle of the connection line of intersections as transformed into prescription of creation of individual marks in a language of used method of printing the marks according to type of used symbolic data mark. Output of this block is created by data for creation of bitmap of data marks for print, which are forwarded printing facility, for instance to a laser printer E or to another proper printer (bubble printer, thermotransfer, etc.), which prints the marks together with the original form of printed document on a printing substrate (paper) F.

The printing substrate is forwarded asynchronously to a scanning facility, i.e. reading data symbolic marks from paper to computer G. This facility consists for instance of a scanner and computer where recognition of structure and content of marks has been carried out. This content of data symbolic marks is forwarded to a next facility of transformation of read data into a format of binary data series I. In this facility recognition of binary value is being carried out, which the mark carries together with distortion data and data of distortions of reading process H. Further, inverse transformation of permutation I1 of self-correction de-coding (e.g. Reed-Solomon I2), then the test of electronic signature I3, data de-coding I4, etc. are carried out over the raw chain of binary data. Transformed data are after inverse operations forwarded into the block-facility, which transforms reconstructed data into the same format as the format of original data source, or into the format which is used in the following operations (e.g. calling database operations) J.

The facility-block at the beginning of the chain, where the bitmap is created in a language of a printing facility, can be supplemented with a block for creating modulation of marks D. This block, without disturbing the information content of the marks, changes their geometrical shape in such a way, that, when looking at the printed bitmap, visual perception of surface projection is apparent (e.g. company logos, state symbol or other graphics). Such a graphical picture is divided into hundreds and thousands of marks and each mark contains enlarged or reduced content of printing black colour without affecting its basic function as a data carrier.

Described facilities can be implemented as separate physical blocks containing data-processing programmable capacity, or can be concentrated into one or two computer programmable capacities.

1. Data channel of the background containing symbolic data marks, which include aggregate, constant number of dark elements in the whole record, which is characterized by:
recording medium, such as paper or other recording print carrier,
data symbolic marks printed on record medium arranged into a grid on positions with periodically repeating properties in both horizontal and vertical directions,
textual or graphical print printed in overlay with data symbolic marks,
elements of modulation of the record by graphic pattern.

2. System for data recording on paper, or other carrier, and reading machine readable marks, which is characterized by:
means for transforming and formatting source data to a sequence of digital data embedded in individual symbolic data marks;
means for coding such data sequence onto a format consisting of a description of a symbolic data mark in the language of the used printing method;
means dedicated for printing a record on paper or other printing substrate,
means for reading data symbolic marks from paper or other carrier into a computer;
means for transforming the read data of the data sequence format which are represented by individual symbolic data marks;
means for transforming into the format of data which served as a source for recording symbolic data marks or to other chosen format;
means for modulation of marks by a source graphic pattern.

3. Method of recording, determination of the location and number of dark elements for coding dual represented statuses in a symbolic data mark for data recording and reading on paper or other carrier of such mark, wherein these dark elements represent on an area available for one symbolic mark two statuses with constant number of dark elements, which change only position, is characterized by:
determination of the axes of symmetry of a two-dimensional area dedicated for a symmetric data mark and determination of a coordinate system in regard to these symmetry axes,
determination of the aggregate area of the mark, i.e. the number of dark elements used for coding two statuses for data representation on area allocated for the symbolic data mark,
determination of the maximal allowed distance of dark points from a line of equal distance from both the axes of symmetry and minimal allowed distance from each of the symmetry axes,
calculation of the aggregate of the absolute values of both co-ordinates for each possible location of a dark element,
determination of areas of maximal distance from both the axes in compliance with the aggregate and allowed maximal and minimal distances from axes,
recording one half of the maximal allowed number of elements in one of the areas determined in previous step within the limits of the area allocated for the symbolic data mark as one half of a symbol representing one of the two statuses which could be represented by the symbolic data mark,
recording the second half of the maximal allowed number of elements in the next of the determined areas on the opposite side of both the symmetry axes, within the limits of the area allocated for the symbolic data mark as the second half of the symbol representing one of the two statuses which could be represented by the symbolic data mark, choosing the locations of dark elements located symmetrically to the second symmetry axis with respect to the recorded elements as locations of elements representing the second status of two statuses representing the symmetric data mark,
determination of the areas of maximal distance from each of the symmetry axes individually,
recording the maximal allowed number of elements in one of the determined areas within the limits of the area allocated for the symbolic data mark as a symbol representing one of the two statuses which could be represented by the symbolic data mark,
choosing the locations of dark elements located symmetrically to such an axis of symmetry that does not intersect the chosen locations of dark elements with respect to the recorded elements as the locations of the elements representing the second status of the two statuses represented by the symbolic data mark.

4. Method of recording according to claim 3, where reading marks and the data status represented by them on expected area of paper or other carrier containing dark and light elements and allocated for the symbolic mark is characterized by the fact that it consists of:
evaluation of the status of areas minimally in four corners of a rectangular with maximal dimension allowed for arrangement of the mark with regard to presence of dark elements in a number greater than a certain threshold p,
determination of one status from the collection of possible statuses of the evaluated areas of the read mark according to over-threshold number of dark elements presented in the four areas evaluated in the previous step minimally,
determination of the data value represented by the symbolic mark in the case of the first sub-collection of statuses of the areas evaluated in previous step, which is characterised by presence of dark elements in over-threshold number in two diagonally opposite areas or also in the third of four evaluated areas,
evaluation of the statuses of four areas located always on the shortest non-diagonal connection line between two areas evaluated in previously mentioned step in the case of the second sub-collection of the statuses of the areas evaluated in previously mentioned step, which is characterised by a number of dark elements presented in over-threshold number in two non-diagonal or in all four evaluated areas, or those characterised by an under-threshold number of dark elements in all four evaluated areas in previously mentioned step,
determination of the represented data value of the symbolic mark in the case of the second sub-collection of the areas evaluated in previously mentioned step according to the result of evaluation of the status of four areas evaluated in previously mentioned step,
repeating of the previous step sequence, but with the centre of the evaluated rectangular moved to the corner area that was evaluated before with presence of dark elements presented in a number above the number p, in the case of the third sub-collection of the areas evaluated before, which is characterised by presence of dark elements in over-threshold number in one of the evaluated areas only,
determination of the represented data value of the symbolic mark, if repeating of the previous steps initialised by the previous step results at the second execution of step 2.6 in a return of the centre of the evaluated rectangle towards the original position of the beginning of the process of reading the mark,
correction of the expected location of the following read symbolic marks according to the results of previous steps.

5. Method of recording according to claim 3, consisting in modulation of the total aggregate quantity value of the dark elements of the symbolic data mark, which is characterised by the fact that it consists of:
selection of the number of dark elements from interval from 0 to the maximal allowed number of dark elements, that is appropriate to the quantity value level of the corresponding point of the pattern that is viewed by modulation on the grid of symbolic data marks,
adding the selected number of dark elements onto positions nearest to both symmetry axes of the data symbolic mark, preferring an even number located symmetrically to both symmetry axes,
adding the number of dark elements selected in the previous step onto free locations adjacent to the elements representing each data status with the maximal distance from both symmetry axes.

6. Method of recording according to claim 3, consisting in initial localisation of the locations of the beginnings and ends of the rows and columns of symbolic data marks, which is characterised by the fact that it involves:
evaluation of the scanned field representing the bright value of the image points of the read document in one direction horizontally or vertically, point by point,
evaluation of successive image points from a margin of the paper or other carrier, where a change to under-threshold value and back must occur 1 times with an average periodicity of m points, wherein such a first point with an over-threshold value represents one of the minimums of the horizontal or vertical co-ordinates, which specify origins of the rows or columns,
creation of a curve of the minimums F obtained in the previous step,
filtration of the points of the curve F obtained in the previous step by elimination of extreme values through a substituting for all points an average of p points, which are symmetrically placed around the substituted point of the original curve,
creation of a straight line of a linear approximation of the filtered curve,
placing a straight line R parallel to the straight line of the linear approximation, all co-ordinates of which are smaller than those of the point with the minimal co-ordinate in horizontal or vertical direction,
translation moving of the straight line R towards the found points,
finding a first intersection O of the moved straight line R with the filtered curve F of the minimums from previous step,
rotating the straight line R around the point O till a next intersection D with the filtered curve F is found, eliminating the points of the curve F, which are more distant to the straight line R located in the position found in previous step than the distance q, and obtaining a resulting curve S,
finding the nearest point of the curve F to the straight line R in each of point clusters, where these clusters are of an average periodicity of h (vertically) or m (horizontally), repeating the previous steps in the next three directions i.e. for vertical direction, for the horizontal direction backwards to previous points and for vertical direction backwards to the first executed vertical direction,
detecting of perpendicularity and parallelism to each other of the resulted straight lines, correction of a line, which is neither perpendicular nor parallel to any straight lines of the three left,
determination of the margins of the field of the marks according to at least three straight lines.

7. Method of recording symbolic data marks by means of dark and light elements placed on paper or a similar carrier of print information, which is characterised by the fact that it involves:
defining a grid of two systems of axes, a horizontal one and a vertical one, perpendicular to each other with equal or different relative distance in horizontal and vertical directions, on a paper area dedicated for recording symbolic data marks,
determining a maximal allowed number of dark elements for a symbolic data mark,
placing one system of symbolic data marks onto the area of lines connecting two intersections of each horizontal axis with vertical axes in a way, that a one logical status represented by the symbolic data mark has the majority or all of its dark elements placed on one half of the mentioned connecting line or close to it and the second logical status represented by the symbolic data mark has the majority or all its dark elements placed on the second half of the mentioned connection line or close to it,
placing the second system of symbolic data marks in the area of lines connecting two intersections of each vertical axis with horizontal axes so that a one logical status represented by the symbolic data mark has the majority or all of its dark elements placed on one a half of the mentioned connecting line or close to it and the second logical status represented by the symbolic data mark has the majority or all its dark elements placed on the second half of the mentioned connection line or close to it,
placing dark elements to positions maximal outlying to the centre of a line connecting intersections of the two systems of axes,
placing the dark elements of the mark in such a way, that they are in minimal allowed distance v from the mentioned intersections of the horizontal and vertical axes,
placing the dark elements of the mark in such a way, that they are in maximal distance d from a line connecting intersections of the horizontal and vertical axes.

8. Method of recording of symbolic data marks according to claim 5 and the data status represented thereby on an expected area of paper or other carrier containing dark and light elements and allocated for a symbolic mark, which is characterised by the fact that it includes:
result of comparison of the quantitative values compared in the previous step,
usage of the corrections of the vertical and horizontal expected positions of adjacent marks determined in previous steps prior to their evaluation according to the sequence of previous steps.

9. Method of recording according to claim 7 with modulation of an area of a document by modulating marks inserted onto a field of placed symmetric data marks, where the marks are recorded on paper or other carrier by graphical information, which is characterised by the fact that it involves:
transformation of graphical information from the original format of modulating marks to such format that is given by a sub-collection of a grid of symbolic marks specified for inserting modulating marks and determination of quantitative parameters of individual modulating marks,
transformation of the quantitative parameters of individual modulating marks into a sub-collection of the dark elements creating such modulating mark,
recording the collection of dark elements creating individual data modulating marks on an area near to the points which are evenly distant from the vertical as well as horizontal axes that determine the location of symbolic data marks according to claim 7.

10. Method of recording according to claim 7 with searching of the co-ordinates of the beginnings and ends of the rows and columns of the horizontal and vertical lines on which symbolic data marks are placed, which is characterised by the fact that it consists of:
evaluation of plurality of n horizontal lines arranged basically throughout the whole vertical length of a margin of dark points, proceeding horizontally from a one margin of the scanned paper, or other substrate up to a point, in which the dark points are presented in a number higher than the threshold p_{z} value,
leading a linear approximation through all points specified in the previous step, elimination of the points, which are more distant from the straight line of that linear approximation than a distance vi,
leading a new linear approximation through points, which remained from the previous step, elimination of the points, which are more distant from the straight line of the new linear approximation than a distance Vj+i<Vi,
repeating the previous stepstill Vi<H,
repeating the previous steps in a backward horizontal direction from the second margin of the paper,
evaluation of status of chosen areas on either sides from the centre of an expected horizontal connection line between two intersections of horizontal and vertical axes as regards presence of dark elements and their quantitative values,
comparison of the aggregate of quantitative values of the dark elements located in the chosen areas on one side from the centre of the mentioned connecting line towards the first intersection of axes with the aggregate of the quantitative values of the dark elements located in the chosen areas on the other side from the centre of the mentioned connecting line towards the second intersection of the axes,
comparison of the aggregate of quantitative values of the dark elements located in the chosen areas on one side of the mentioned connecting line with the aggregate of the quantitative values of the dark elements located in the chosen areas on the other side of the mentioned connecting line,
determination of represented data value of the symbolic data mark according to result of comparison of the quantitative values compared in the previous step,
determination of the size of correction of the expected position of evaluated symbolic data mark, adjacent and near marks, in particular in the vertical direction according to result of comparison of the quantitative values compared in the previous step,
evaluation of the status of chosen areas on either sides from the centre of expected vertical connection line between two intersections of vertical and horizontal axes as regards presence of dark elements and their quantitative values,
comparison of the aggregate of the quantitative values of the dark elements located in the chosen areas on one side from the centre of the mentioned connecting line towards the first intersection of the axes with the aggregate of the quantitative values of the dark elements located in the chosen areas on the other side from the centre of the mentioned connecting line towards the second intersection of the axes,
comparison of the aggregate of the quantitative values of the dark elements located in the chosen areas on one side of the mentioned vertical connecting line with the aggregate of the quantitative values of the dark elements located in the chosen areas on the other side of the mentioned vertical connecting line,
determination of the represented data value of the symbolic data mark according to the result of the comparison of the quantitative values compared in the previous step,
determination of size of correction of the expected position of the evaluated symbolic data mark, adjacent and near marks, in particular in the horizontal direction according to repeating the previous steps in both vertical directions, i.e. in the direction of columns, for selected horizontal direction of evaluation of symbolic data marks (rows), a straight line will be led parallel to the straight line of linear approximation of expected beginnings of rows in distance equal to one half distance of the vertical lines of the symbolic data marks location,
whereon symbolic data marks of the first system of symbolic data marks are located,
finding the first symbolic data mark on the straight line led in the previous step, in distance equal to a half distance of the horizontal lines of the location of the second system of symbolic data marks from the straight line of linear approximation of the expected beginnings of columns obtained in the previous,
finding next marks according claim 8.

11. Method of recording according to claims 3 or 7, where dark elements can be of next characteristics differentiating them from light elements, which is characterised by the fact that it involves:
dark elements having quantitative values or value intervals of a value scale of an arbitrary optical characteristic representing two logical statuses of a data symbolic mark, wherein these dark elements consist of a one or more image elements (pixels) having a higher quantitative value or interval of the value scale of the optical characteristic chosen for representation of the two statuses,
dark elements according to the previous point, where the surroundings of a symbolic data mark is of a quantitative value or interval different from two values or intervals representing two statuses of the symbolic data mark,
dark elements with an optical characteristic of a half tone scale,
dark elements with an optical characteristic of a colour scale.

12. Method of preparation of data channel of the background according to claim 3 or 7, which is characterised by the fact that it consists of a human readable text or graphical patterns in overlay with data symbolic marks.

13. Method according to claim 12, which is characterised by the fact that the data channel contains data that represent human readable data printed on the same substrate or transformation of such data or pattern readable by a human.

14. Method according to claim 12, which is characterised by the fact that the data channel contains also safety protection, e.g. electronic signature, human readable data printed on the same substrate.

15. Method of transparent protection of a document dedicated for printing which is transparent in regard to application as well as to the inherent data contents of the document by means of a field of symbolic data marks, in particular according to claims 3 or 7, wherein this field is printed in overlay by print of the inherent document, wherein this protection provides selective data and security continuity of electronic and paper document in both directions, i.e. from electronic version of the document to form printable on paper and from paper form of the document back to electronic version of the document which characterized by the following steps:
extracting a part of data contents dedicated for document protection which can include also positional information on the printed document from the file dedicated for print by the original application,
extracting other document contents, including also invariable data in a set of documents of the same kind, from the file dedicated for print by the original application,
transforming data extracted in the first or also in second step, according to a set of algorithms including also cryptographic, compress algorithms and procedures, electronic signature, self corrective coding and data preparation for mark modulation by a graphic information,
transforming the data from the previous step to a form suitable for printing a field of two-dimensional symbolic data marks representing the mentioned data, for instance such as described in other items of this invention, but not limited on those only, arranged in rows and columns placed in the print document on a substantial document area, principally independently of the area used for printing the original document, the complete file data of which were used as input in the previous step,
printing carried out by overlaying a print of the original document that is printed concurrently or in time sequence with the print of two-dimensional data symbol marks on paper or another carrier,
scanning the printed protected document by a scanner or other similar equipment, and input of the scanned data into computer,
processing the read data of the mutually overlaid print of the original document by a field of symbolic data marks, recognising, extraction of data represented by the field of symbolic data marks,
transforming the recognised and extracted data by a set of algorithms including also cryptographic, decompress algorithms and procedures, electronic signature, self corrective decoding,
visualisation on a visualising equipment of the recognised and processed data, i.e. the part of data contents determined for protection,
linking the recognised and processed data from the previous step with the data of other document contents from the previous step till full reconstruction of the file document in its complete form as it was used for purposes of previous steps, however not limited on complete form only,
visualisation of the complete document on a visualising equipment.
